(19) United States
(12) Patent Application Publication
(10) Pub. No.: US 2009/0099039 A1
(43) Pub. Date: Apr. 16, 2009

(54) BINARY-COUPLED PROBE ARRAY, BIOCHIP, AND METHOD OF FABRICATION

(75) Inventors: Won-Sun KIM, Gyeonggi-do (KR); Hyeong-Jun KIM, Seoul (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 12/244,530

(22) Filed: Oct. 2, 2008

(30) Foreign Application Priority Data
Oct. 2, 2007 (KR) 10-2007-0099256

(51) Int. Cl. C40B 40/00

(52) U.S. Cl. 506/13

(57) ABSTRACT

A binary-coupled type probe array for analyzing components of a biological sample using probes, a biochip, and a method of fabricating the same, are provided. The binary-coupled probe array can include a substrate, a plurality of first probes immobilized on a top surface of the substrate, and a plurality of second probes immobilized on a bottom surface of the substrate.

### CROSS-REFERENCE TO RELATED APPLICATION

This application claims priority to Korean Patent Application No. 10-2007-0099256, filed Oct. 2, 2007, the disclosure of which is incorporated herein by reference in its entirety.

### BACKGROUND

The disclosed technology relates to a binary-coupled type probe array, a biochip, and a method of fabricating the same, and more particularly, to a binary-coupled type probe array for analyzing components of a biological sample using probes, a biochip, and a method of fabricating the same.

### SUMMARY

The disclosed technology provides a binary-coupled type probe array having improved reliability and throughput.

The disclosed technology also provides a biochip having improved reliability and throughput.

The disclosed technology also provides a method of fabricating a binary-coupled type probe array having improved reliability and throughput.

The disclosed technology also provides a method of fabricating a biochip having improved reliability and throughput.

The above and other objects of the disclosed technology will be described in or be apparent from the following description of various embodiments.

Certain embodiments provide a binary-coupled probe array including a substrate, a plurality of first probes immobilized on a top surface of the substrate, and a plurality of second probes immobilized on a bottom surface of the substrate.

Other embodiments provide a binary-coupled probe array including a substrate including two or more sub-substrates combined with each other, a plurality of first probes immobilized on a top surface of the substrate, and a plurality of second probes immobilized on a bottom surface of the substrate.

Still other embodiments provide a biochip including a substrate, a plurality of first probes immobilized on a top surface of the substrate, and a plurality of second probes immobilized on a bottom surface of the substrate.

Further embodiments provide a method of fabricating a binary-coupled probe array including providing a substrate having a top surface and a bottom surface, forming a plurality of first probes immobilized on a top surface of the substrate, and forming a plurality of second probes immobilized on a bottom surface of the substrate.

Still further embodiments provide a method of fabricating biochips including providing a binary-coupled probe array including a substrate, a plurality of first probes immobilized on a top surface of the substrate, and a plurality of second probes immobilized on a bottom surface of the substrate, and separating the binary-coupled probe array into independent biochips by cutting the binary-coupled probe array.

### BRIEF DESCRIPTION OF THE DRAWINGS

The above and other features and advantages of the disclosed technology will become more apparent by describing in detail various embodiments thereof with reference to the attached drawings in which:

FIG. 1 is a partial layout view of binary-coupled type probe arrays according to certain embodiments of the disclosed technology;

FIG. 2 is a sectional view of a binary-coupled type probe array according to an embodiment of the disclosed technology;

FIG. 3 is a sectional view of a binary-coupled type probe array according to another embodiment of the disclosed technology;

FIG. 4 is a sectional view of a binary-coupled type probe array according to still another embodiment of the disclosed technology;

FIG. 5 is a sectional view of a binary-coupled type probe array according to a further embodiment of the disclosed technology;

FIGS. 6 through 10 are sectional views of intermediate structures illustrating a method of fabricating binary-coupled type probe arrays according to certain embodiments of the disclosed technology; and

FIG. 11 is a sectional view of intermediate structures illustrating a method of fabricating biochips according to certain embodiments of the disclosed technology.

### DETAILED DESCRIPTION

Advantages and features of the disclosed technology and methods of accomplishing the same may be understood more readily with reference to the following detailed description of various embodiments and the accompanying drawings. The disclosed technology may, however, be embodied in many different forms and should not be construed as being limited to the embodiments set forth herein. Rather, these embodiments are provided so that this disclosure will be thorough and complete and will fully convey various concepts of the disclosed technology to those skilled in the art, and the present invention will only be defined by the appended claims. Like reference numerals refer to like elements throughout the specification.

Therefore, in some embodiments, well-known process procedures, structures, and techniques will not be described in detail to avoid misinterpretation of the present invention.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In the drawings, the thickness of layers and regions may be exaggerated for clarity.

It will be understood that when an element or layer is referred to as being “on” or extending “onto” another element, it can be directly on or extend directly onto the other element or intervening elements may also be present. In contrast, when an element is referred to as being “directly on” or extending “directly onto” another element, there are no intervening elements present. As used herein the term “and/or” includes any and all combinations of one or more of the associated listed items.

A binary-coupled probe array and a biochip according to certain embodiments of the disclosed technology analyze biomolecules contained in biological samples and are typically used in gene expression profiling, genotyping through detection of mutation or polymorphism such as Single-Nucleotide Polymorphism (SNP), a protein or peptide assay, potential drug screening, development and preparation of novel drugs, etc. Binary-coupled probe arrays and biochips employ appropriate probes according to the kind of biological sample to be analyzed. Examples of the probes useful for binary-coupled probe arrays and biochips include a DNA probe, a protein probe such as an antibody/antigen or a bacteriorhodopsin, a bacterial probe, a neuron probe, and so on. According to the kind of probe used, the binary-coupled probe array and the biochip may be referred to a DNA chip, a protein chip, a cellular chip, a neuron chip, and so on.

In exemplary embodiments of the disclosed technology, the binary-coupled probe array and the biochip may comprise oligomer probes. That is, the number of monomers contained in the oligomer probe is at an oligomer level. As used herein, the term “oligomer” is a low-molecular weight polymer molecule consisting of two or more covalently bound monomers. Oligomers have a molecular weight of about 1,000 or less but the disclosed technology is not limited thereto. The oligomer may include, but is not limited to, about 2-500 monomers, or preferably 5-30 monomers. However, the features of the oligomer probe are not limited to being characterized by the ranges listed above. The monomers constructing an oligomer probe may be nucleosides, nucleotides, amino acids, peptides, etc. according to the type of biological sample to be analyzed.

As used herein, the terms “nucleosides” and “nucleotides” include not only known purine and pyrimidine bases, but also methylated purines or pyrimidines, acylated purines or pyrimidines, etc. Furthermore, the “nucleosides” and “nucleotides” include not only known (deoxy)ribose, but also a modified sugar in which a halogen atom or an aliphatic group is substituted for at least one hydroxyl group or which is functionalized with ether, amine, or the like. As used herein, the term “amino acids” are intended to refer to not only naturally occurring, L-, D-, and nonchiral amino acids, but also modified amino acids, amino acid analogs, etc. As used herein, the term “peptides” refer to compounds produced by an amide bond between the carboxyl group of one amino acid and the amino group of another amino acid.

Unless otherwise specified in the following exemplary embodiments, the term “probe” is a DNA probe, which is an oligomer probe consisting of about 5-30 covalently bound monomers. However, the disclosed technology is not limited to the probes listed above and a variety of probes may used.

Embodiments of the disclosed technology will now be described with reference to the accompanying drawings.

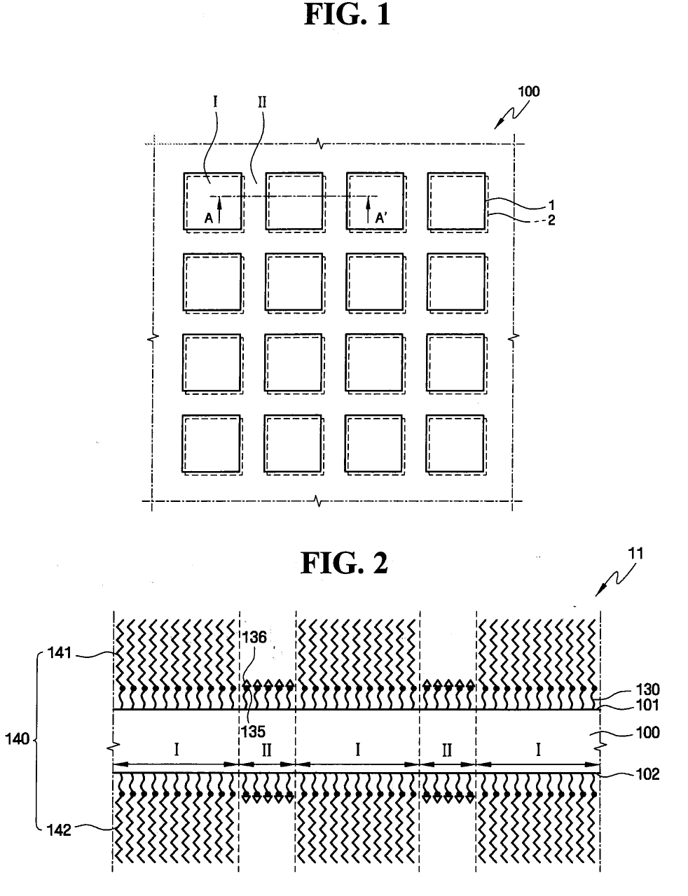

FIG. 1 is a partial layout view of binary-coupled type probe arrays according to certain embodiments of the disclosed technology.

Referring to FIG. 1, a substrate 100 for a binary-coupled type probe array according to an exemplary embodiment of the disclosed technology includes a plurality of probe cell regions I and a non-probe cell region II. The probe cell regions I and the non-probe cell region II are defined according to the presence or absence of immobilized probes. In other words, the probe cell regions I of the substrate 100 are regions of the substrate 100 on which a plurality of plurality of probes are immobilized, while the non-probe cell region II 100 is a region of the substrate 100 on which the probes are not immobilized. First and second probe cells 1 and 2 each include a plurality of immobilized probes that are formed on respective probe cell regions I of the substrate 100. In detail, the first probes 1 are formed on a top surface of the substrate 100 and the second probes 2 are formed on a bottom surface of the substrate 100.

While probes having the same sequences are immobilized on a probe cell region I, probes having different sequences may be immobilized on different probe cell regions I . This is also true with probes immobilized on the bottom surface of the substrate 100. With regard to probe arrays formed on the top and bottom surfaces of the substrate 100, sequences of the respective probe arrays may be different from or the same as each other. In other words, the first and second probes 1 and 2 formed on the top and bottom surfaces of the substrate 100 may be arrayed such that they face each other with respect to the substrate 100, which will later be described in more detail.

The different probe cell regions I are separated from each other by the non-probe cell region II. Thus, each probe cell region I is surrounded by the non-probe cell region II. The plurality of probe cell regions I may be arranged in a matrix configuration. Here, the matrix configuration does not necessarily have a regular pitch.

Unlike the independent probe cell regions I , the non-probe cell regions II may connect to form a single unit. For example, the non-probe cell regions II may be arranged in a lattice configuration.

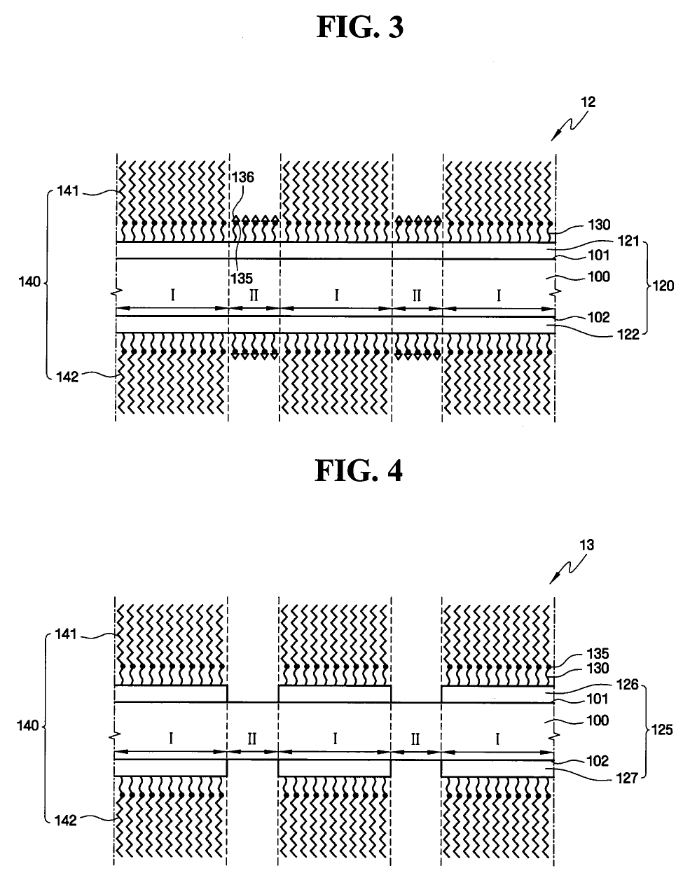

FIG. 2 is a sectional view of a binary-coupled type probe array according to an embodiment of the disclosed technology.

Referring to FIG. 2, the binary-coupled type probe array 11 according to an embodiment of the disclosed technology includes a substrate 100, a plurality of first probes 141 formed on a top surface 101 of the substrate 100, and a plurality of plurality of second probes 142 formed on a bottom surface of the substrate 100.

The substrate 100 may be a substrate made of a transparent material allowing visible light and/or UV light to pass through. For example, the substrate 100 may be a transparent substrate made of glass, soda-lime glass, or quartz. When a glass substrate is used, it can be advantageously compatible with substrates that have been widely used for various known applications, including relatively thin slide substrates for use in, for example, microscopic observation, relatively thick, large-screen liquid crystal display (LCD) panels, and so on. In certain other embodiments of the disclosed technology, an opaque substrate may be used.

When a transparent substrate, e.g., a glass substrate, is used as the substrate 100, visible light and/or UV light are allowed to pass through the substrate 100, thereby deprotecting functional groups formed on both the top surface 101 and the bottom surface 102. The use of a transparent glass substrate is advantageous in that it is possible to form binary-coupled probe arrays in which first and second probes 141 and 142 have sequences corresponding to each other in view of the substrate 100.

In certain other embodiments of the disclosed technology, an opaque substrate may be used.

When an opaque substrate is used, light typically cannot reach protecting groups formed on the bottom surface 102, so that only the protecting groups formed on the top surface 101 can be deprotected. Thus, the first and second probes 141 and 142 may have different sequences. The functional groups, protecting groups and deprotection will later be described in more detail.

The substrate 100 may be in a partially separated phase incorporating defects. In detail, continuous defects formed to be parallel with a surface of the substrate 100 may be formed within the substrate 100. The defects can be subjected to, for example, hydrogen plasma treatment. The defects formed within the substrate 100 can cause the upper and lower plates of the substrate 100 to easily separate due to relatively weak binding forces of the defects.

The substrate 100 includes the top surface 101 and the bottom surface 102. In addition, the linkers 130 are formed on the top surface 101 and the bottom surface 102, respectively. A first end of each of the linkers 130 may be coupled to the top surface 101 or the bottom surface 102 of the substrate 100, and a second end of each of the linkers 130 containing functional groups 135 may be coupled to each probe 140.

The functional groups 135 may be atomic groups that can be used as starting points for organic synthesis. That is, the functional groups 135 may be atomic groups capable of coupling with (i.e., covalently or non-covalently binding with) the previously synthesized oligomer probes or monomers (e.g., nucleosides, nucleotides, amino acids, or peptides) for in-situ synthesis of the oligomer probes. The functional groups 135 are not limited to any particular functional groups, provided that they can be coupled to the oligomer probes or the monomers for in-situ synthesis of the oligomer probes. Examples of the functional groups 135 include hydroxyl groups, aldehyde groups, carboxyl groups, amino groups, amide groups, thiol groups, halo groups, and sulfonate groups.

When the substrate 100 is made of, for example, glass, each of the linkers 130 may contain at the first end a silicon group capable of reacting with Si(OH) groups on the surface of the substrate 100 to produce siloxane (Si—O) bonds. Examples of materials used for the linkers 130, including the silicon group as well as the functional groups 135, that can be coupled to the probes 140 (here, the probes 140 include monomers for probe synthesis) include N-(3-(triethoxysilyl)-propyl)-4-hydroxybutyramide, N,N-bis(hydroxyethyl) aminopropyl-triethoxysilane, acetoxypropyl-triethoxysilane, 3-Glycidoxy propyltrimethoxysilane), and silicon compounds as disclosed in PCT application WO 00/21967, the contents of which are hereby incorporated by reference.

The linkers 130 may include spacers (not shown) providing a spatial margin for a free interaction with a target sample. If the linkers 130 have a sufficient length to ensure a free interaction, the spacers may not be provided, as in the illustrated example.

The plurality of first probes 141 are immobilized on the top surface 101. Here, the immobilizing of the first probes 141 on the top surface 101 is performed through mediation of the linkers 130. In the probe cell regions I, the plurality of first probes 141 may be coupled to the second ends of the linkers 130. The linkers 130 may be formed on the entire top surface 101 of the substrate 100, regardless of whether they are in either the probe cell regions I or the non-probe cell region II. However, the probes 140 are selectively coupled to only the linkers 130 positioned in the probe cell regions I of the substrate 100.

Second ends of the linkers 130 positioned in the non-probe cell region II of the substrate 100 may be capped by capping groups 136 to deactivate the functional groups 135 capable of being coupled to the probes 140. The capping groups 136 can prevent the exposed functional groups 135 from participating in chemical reactions at unwanted sites, thereby avoiding synthesis noise or immobilization noise of the probes 140. Furthermore, according to some modified embodiments of the disclosed technology, the linkers 130 may be selectively removed in the non-probe cell region II.

In addition, although not shown in the drawing, when the functional groups 135 capable of being coupled to the probes 140 are contained in the top surface 101 and the bottom surface 102, the linkers 130 may be omitted. In such a case, the functional groups 135 of the top surface 101 in the non-probe cell region II may be inactively capped or selectively removed, as with the linkers 130.

The plurality of second probes 142 are immobilized on the bottom surface 102. As with the first probes 141, the immobilizing of the second probes 142 on the bottom surface 102 is also performed through mediation of the linkers 130. Alternatively, the plurality of second probes 142 may be directly formed on the bottom surface 102 without mediation by the linkers 130. In this manner, immobilization of the second probes 142 is substantially the same as immobilization of the first probes 141.

The second probes 142 may be formed on the respective probe cell regions I on the bottom surface 102 to completely overlap with the same probe cell regions I of the first probes 141 on the top surface 101. The first and second probes 141 and 142 formed on the top and bottom surfaces 101 and 102 of the same probe cell regions I may have different sequences.

Further, the second probes 142 may be formed to face the first probes 141 with respect to the substrate 100. In other words, while the first and second probes 141 and 142 share a single probe cell region I on opposing sides of the substrate 100, they are formed to face each other about the substrate 100, and the first and second probes 141 and 142 facing each other have the same and corresponding sequences (e.g., mirror image sequences) about the substrate 100. According to an embodiment of the disclosed technology, a plurality of binary-coupled type probe arrays are formed on both a top surface and a bottom surface of the substrate 100 and, therefore, the number of probe arrays fabricated is doubled. That is, the yield of a particular process can be enhanced.

Furthermore, since the first and second probes 141 and 142 are formed on both the top and bottom surfaces to have the same sequences, a higher integration density of probe arrays can be achieved, thereby ensuring a sufficient amount of emission even when a reduced design rule is adopted.

When the substrate 100 is separated into upper and lower plates in a subsequent process, the yield can be enhanced because the number of biochips having probe arrays formed on one surface thereof is doubled. In addition, since the first and second probes 141 and 142 are formed on the top and bottom surfaces 101 and 102 of the same probe cell regions I in an aligned manner, separating into individual biochips can be facilitated in a subsequent process.

While maintaining the probes 140 formed on the top and bottom surfaces 101 and 102 in the binary-coupled probe array, when individual biochips are separated, doubling of the integration density of biochips in each probe cell region I can be achieved.

A binary-coupled type probe array according to another embodiment of the disclosed technology will now be described with reference to FIG. 3, which is a sectional view of a binary-coupled type probe array 12 according to another embodiment of the disclosed technology.

The binary-coupled type probe array 12 according to another embodiment of the disclosed technology is different from the binary-coupled type probe array 11 according to the previous embodiment in that it further includes a first active layer 121 formed on the top surface 101 of the substrate 100 and a second active layer 122 formed on the bottom surface 102 of the substrate 100. Here, the second active layer 122 is substantially the same as the first active layer 121 formed on the top surface 101, except that it is formed on the bottom surface 102, and the current embodiment will be described chiefly with regard to an active layer 120 including the first and second active layers 121 and 122.

The active layer 120 may be formed on the entire top surface 101 of the substrate 100, regardless of whether it is in either the probe cell regions I or the non-probe cell region II. The linkers 130 are formed on the active layer 120. When the top surface 101 cannot couple to the linkers 130 and/or the probes 140, or when there are a negligible number of function groups coupled to the linkers 130 and/or the probes 140, the active layer 120 may be advantageously provided.

Further, the active layer 120 may be formed of a material that is substantially stable against hydrolysis upon a hybridization assay (e.g., upon contact with a pH 6-9 phosphate or TRIS buffer). Accordingly, the active layer 120 is preferably made of a silicon oxide film such as a PE-TEOS film, a HDP oxide film, a P-SiH4 oxide film or a thermal oxide film; silicate such as hafnium silicate or zirconium silicate; a metallic oxynitride film such as a silicon nitride film, a silicon oxynitride film, a hafnium oxynitride film or a zirconium oxynitride film; a metal oxide film such as ITO; a metal such as gold, silver, copper or palladium; polyimide; polyamine; or polymers such as polystyrene, polyacrylate or polyvinyl.

A surface of the active layer 120 may have a predetermined degree of roughness in order to ensure sufficient space is provided for coupling with the linkers 130. For example, when the active layer 120 is formed of a thermal oxide film, it may have surface roughness of about 5 nm to about 100 nm.

A first end of each of the linkers 130 is coupled to a top surface of the active layer 120. A second end of each of the linkers 130 containing functional groups 135 is coupled to each probe 140. The material forming the linkers 130 may vary according to the material forming the active layer 120. When the active layer 120 is made of, for example, a silicon oxide film, silicate or a silicon oxynitride film, the linkers 130 may contain a silicon group capable of reacting with Si(OH) groups on the surface of the active layer 120 to produce siloxane (Si—O) bonds. Examples of useful materials are the same as described above. When the active layer 120 is made of a metal oxide film, the functional group at one end of each of the linkers 130 coupled to the active layer 120 may include a metal alkoxide or metal carboxylate group. When the active layer 120 is made of a silicon nitride film, a silicon oxynitride film, a metallic oxynitride film, polyimide, or polyamine, the functional group at one end of each of the linkers 130 coupled to the active layer 120 may include anhydrides, acid chlorides, alkyl halides, or chlorocarbonates. When the active layer 120 is made of a polymer, the functional group at one end of each of the linkers 130 coupled to the active layer 120 may include an acrylic, styryl, or vinyl group.

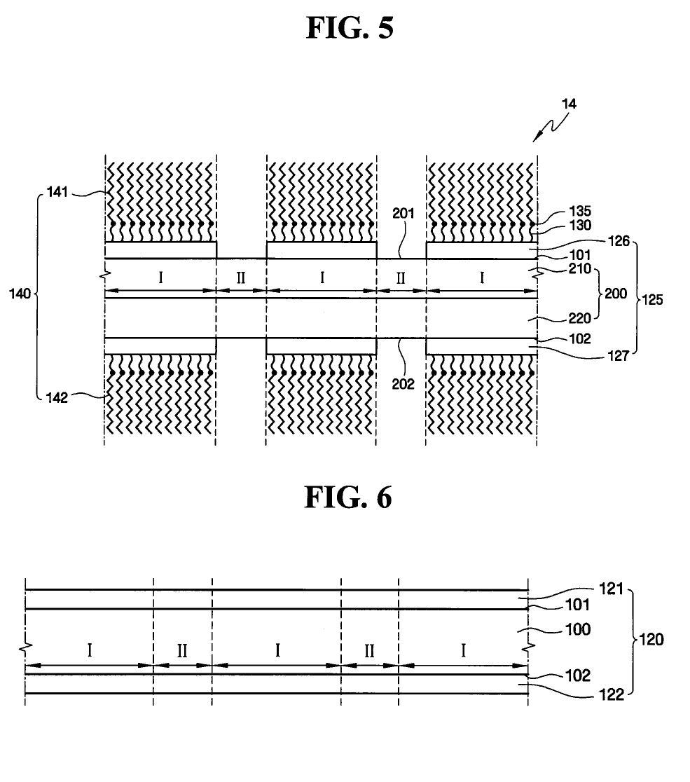

A binary-coupled type probe array according to still another embodiment of the disclosed technology will now be described with reference to FIG. 4, which is a sectional view of a binary-coupled type probe array 13 according to still another embodiment of the disclosed technology.

Referring to FIG. 4, the binary-coupled type probe array 13 according to still another embodiment of the disclosed technology is different from the binary-coupled type probe array 11 according to a previous embodiment in that it further includes a first activation pattern 126 formed on the top surface 101 of the substrate 100 and a second activation pattern 127 formed on the bottom surface 102 of the substrate 100. The second activation pattern 127 is substantially the same as the first activation pattern 126, except that it is formed on the bottom surface 102, and the current embodiment will be described chiefly with regard to an activation pattern 125 including the first and second activation patterns 126 and 127.

Unlike the active layer (120 of FIG. 3) formed on the entire top surface 101 or the entire bottom surface 102 of the substrate 100, the activation pattern 125 is selectively formed only on probe cell regions I of the substrate 100. Since the top surface 101 and the bottom surface 102 share the same probe cell regions I , the first and second activation patterns 126 and 127 are formed in an aligned manner, that is, in the same pattern. Here, materials forming the activation patterns 125 are substantially the same as those of the active layer 120.

The linkers 130 are formed on the activation patterns 125 to mediate the formation of linkages between the probes 140 and the activation patterns 125. Here, the linkers 130 are selectively formed only on the activation patterns 125. Accordingly, the linkers 130 are not formed on the non-probe cell region II where the activation patterns 125 are not formed. As a result, the non-probe cell region II, where the activation patterns 125 are not formed, of the top and bottom surfaces 101 and 102 of the substrate may be directly exposed to the outside.

Since the activation patterns 125 are selectively formed on regions corresponding to the respective probe cell regions I, the probe cells are physically independent of each other due to the activation patterns 125. Furthermore, the probe cells are also chemically independent of each other due to the presence of functional groups 135 capable of being coupled with the probes 140 or the linkers 130 at the probe cell regions. In other words, as a result of formation in different regions of the activation patterns 125 and the linkers 130, the respective probe cells of the binary-coupled probe array 13 are independent of each other physically and chemically.

Although not shown in the drawings, in some embodiments of the disclosed technology, the top surface 101 of the non-probe cell region II may further include a coupling blocking film, a filler, and so on. Further details of structures of the top surface 101 in the non-probe cell region II are fully disclosed in Korea Patent Application Nos. 10-2006-0039713, and 10-2006-0039716, filed by the applicant of the present application, the disclosures of which are incorporated herein in their entirety by reference. If the second ends of the linkers 130 are not inactively capped, unwanted coupling of the probes on the non-probe cell region II can be prevented in a more ensured manner by using the aforementioned structures, as in FIGS. 2 and 3. Accordingly, data noise can be further suppressed, thereby improving the analysis reliability.

A binary-coupled type probe array according to a further embodiment of the disclosed technology will now be described with reference to FIG. 5, which is a sectional view of a binary-coupled type probe array 14 according to a further embodiment of the disclosed technology.

Referring to FIG. 5, the binary-coupled type probe array 14 according to a further embodiment of the disclosed technology is different from the binary-coupled type probe array 13 according to the previous embodiment in that it includes a combined substrate 200 having a first sub-substrate 210 and a second sub-substrate 220 combined with each other.

The combined substrate 200 is substantially the same as the substrate 100 employed in the binary-coupled type probe arrays 11, 12, and 13 according to aforementioned embodiments of the disclosed technology, except that it includes a plurality of sub-substrates 210 and 220.

The first-sub substrate 210 and the second-sub substrate 220 are substantially the same as the substrate 100 employed in embodiments of the disclosed technology that have been described above, and the first-sub substrate 210 and the second-sub substrate 220 constitute the combined substrate 200.

While the illustrated embodiment has described a case in which the combined substrate 200 is constituted of two sub-substrates, the disclosed technology is not limited to the illustrated example and the substrate may have two or more sub-substrates.

First probes 141 are formed on a top surface 201 of the combined substrate 200 constituted of the first-sub substrate 210 and the second-sub substrate 220, and second probes 142 are formed on a bottom surface 202 of the combined substrate 200.

While the illustrated embodiment has described a case in which the first probes 141 and the second probes 142 are immobilized on the top surface 201 and the bottom surface 202 of the combined substrate 200 through linkers 130 and activation patterns 125, the disclosed technology is not limited to the illustrated example and combinations of the current embodiment with the embodiments previously described with reference to FIGS. 2 and 3 can also be implemented. That is, binary-coupled probe arrays according to other embodiments can be implemented by replacing the substrate (e.g., the substrate 100 of FIGS. 2 and 3) employed in the binary-coupled probe arrays 11 and 12 according to previously described embodiments with the first-sub substrate 210 and the second-sub substrate 220. In detail, examples of combinations of the current embodiment with the previously described embodiments may include a binary-coupled probe array including a first-sub substrate 210, a second-sub substrate 220, and a plurality of probes 140 formed on top and bottom surfaces of the combined substrate 200, exposed surface of the first and second sub-substrates 210 and 220, or a binary-coupled probe array further including an active layer 120 formed on top and bottom surfaces of the combined substrate 200, exposed surface of the first and second sub-substrates 210 and 220, and so on.

Hereinafter, biochips according to other embodiments of the disclosed technology will be described referring again to FIGS. 2 through 5.

Each of the biochips according to other embodiments of the disclosed technology includes a substrate 100, a plurality of a plurality of first probes 141 formed on a top surface 101 of the substrate 100 and a plurality of a plurality of second probes 142 formed on a bottom surface 102 of the substrate 100. The biochips can be formed by separating the binary-coupled probe arrays 11, 12, 13, and 14 according to the previously described embodiments into predetermined units. In particular, when the first probes 141 and the second probes 142 having the same sequences are arrayed such that they face each other in view of about the substrate 100, the integration level of probe cells can be enhanced, thereby achieving ensured emission efficiency and higher reliability. Accordingly, higher analysis sensitivity of a biological sample can be achieved even with nano-scale biochips.

Hereinafter, a method of fabricating binary-coupled type probe arrays according to certain embodiments of the disclosed technology will be described with reference to FIGS. 6 through 10. FIGS. 6 through 10 are sectional views of intermediate structures illustrating a method of fabricating binary-coupled type probe arrays according to certain embodiments of the disclosed technology.

Referring to FIG. 6, a substrate 100 including a top surface 101 and a bottom surface 102 is provided. Here, the substrate 100 has probe-cell regions I and non-probe cell regions II. Next, an active layer 120 is formed consiting of a first active layer 121 formed on the top surface 101 and a second active layer 122 formed the bottom surface 102 of the substrate 100. The active layer 120 is formed by, for example, various deposition processes well-known in the art or a thermal oxidation process.

When the thermal oxidation process is employed, the substrate 100 is annealed at a temperature in a range of about 900° C. to about 1200° C. for about 3 hours to about 12 hours. The active layer 120 made of thermal oxide may be formed on both the top surface 101 and the bottom surface 102 by the annealing process. The active layer 120 formed by the thermal oxidation process may have a surface roughness of about 5 nm to about 100 nm.

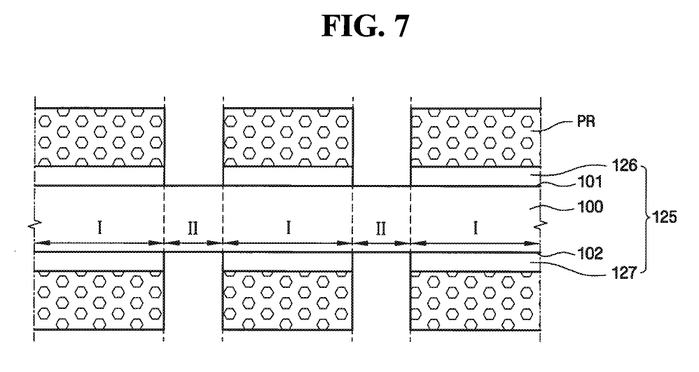

Next, referring to FIG. 7, photoresist patterns PR are formed on the active layer (e.g., the active layer 120 of FIG. 6) to open the non-probe cell region II, and the active layer 120 is etched using the photoresist patterns PR as etching masks to form the activation patterns 125, which consist of a first activation pattern 126 on the top surface 101 and a second activation pattern 127 on the bottom surface 102. Upon etching, the probe cell regions I of the substrate 100 are covered by the activation patterns 125 while top and bottom surfaces 101 and 102 of the substrate 100 in the non-probe cell region II are exposed. Next, the photoresist patterns PR are removed.

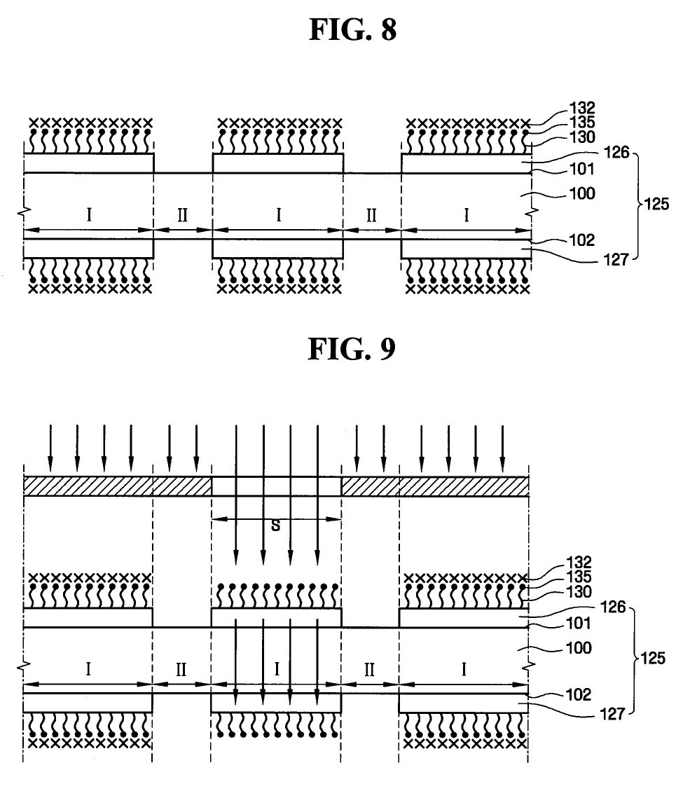

Then, referring to FIG. 8, the linkers 130 are formed on the top and bottom surfaces 101 and 102. Here, the forming of the linkers 130 may be performed by, for example, dipping. As described above, the activation patterns 125, which are substantially the same as the active layer 120, can be easily coupled to one end of the linkers 130. Thus, the linkers 130 can be formed on both the top surface 101 and the bottom surface 102 by a dipping process in which the substrate 100 is dipped into a linker solution containing the linkers 130. The forming of the linkers 130 is not limited to the dipping process and any technique can be used as long as the linkers 130 can be formed on both the top surface 101 and the bottom surface 102.

The linkers 130 may include functional groups 135 and protecting groups 132. The functional groups 135 are typically the same as described above, and the protecting groups 132 may be coupled to the functional groups 135. Here, the protecting groups 132 may be atomic groups that are unable to participate in chemical reactions at their coupling sites. In addition, the protecting groups 132 may be either acidlabile or photolabile, and can be deprotected by acid or light. The term “deprotected” as used herein means that the protecting groups 132 are cleaved from their coupling sites by acid or light to expose the functional groups 135, enabling participation in chemical reactions.

Next, referring to FIG. 9, a predetermined area S of the substrate 100 is selectively exposed to light to deprotect the protecting groups 132 formed on the top surface 101 and the bottom surface 102.

The predetermined area S may be, for example, a probe cell region I. Since a binary-coupled probe array generally has probes of the same sequence at each probe cell, the substrate 100 can be exposed to light for deprotection in units of probe cell regions I.

As described above, when the substrate 100 is a transparent substrate, exposure is performed such that the light passes through the substrate 100, thereby deprotecting not only the protecting groups 132 formed on the top surface 101 but also the protecting groups 132 formed on the bottom surface 102. In other words, the protecting groups 132 formed on the top surface 101 and the bottom surface 102 in the same probe cell region I can be simultaneously deprotected. Accordingly, the predetermined area S of the top surface 101 and the bottom surface 102 includes exposed functional groups 135 that enable chemical reactions.

Alternatively, the protecting groups 132 formed on the top surface 101 and the bottom surface 102 can be separately deprotected by using an opaque substrate. In this case, a binary-coupled probe array having different sequences formed on the top surface 101 and the bottom surface 102 can be fabricated in a subsequent process.

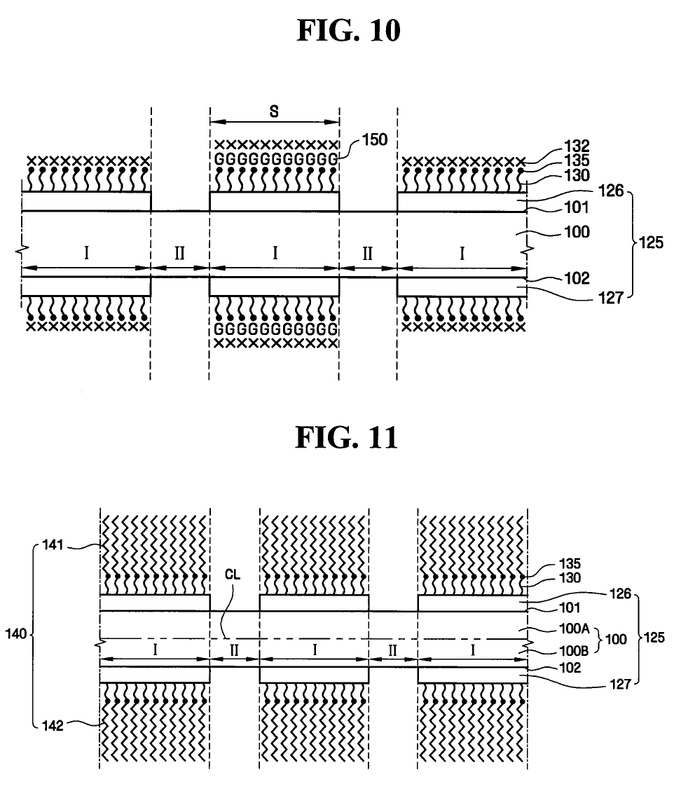

Next, referring to FIG. 10, monomers 150 are coupled to the predetermined region S that has been deprotected. In detail, the monomers 150 are coupled to the exposed functional groups 135 on the top surface 101 and the bottom surface 102. Although FIG. 10 shows that the monomers 150 are guanines (G), various monomers can be employed according to an intended use of the binary-coupled probe array. Here, the monomers 150 may contain the protecting groups 132, to prevent chemical reactions of the coupled monomers 150. In other words, unless selective exposure of the monomers 150 is performed again, the monomers 150 generally do not couple to other monomers.

Referring back to FIG. 4, a plurality of probes 140 having multiple sequences can be formed by repeatedly performing in-situ the deprotection of the protecting groups (e.g., the protecting groups 132 of FIG. 9) using the selective exposure and the coupling of the monomers (e.g., the monomers 150 of FIG. 10).

As described above, when exposure is performed such that the light passes through a predetermined area (e.g., the area S of FIG. 9) of the top surface 101 and the bottom surface 102, the plurality of probes 140 formed on the top surface 101 and the bottom surface 102 are arrayed to face each other about the substrate 100.

Here, after coupling the monomers 150 to the functional groups 135, some functional groups 135 that have been deprotected may remain exposed because they have not successfully coupled with the monomers 150. In order to prevent noise from being generated by uncoupled functional groups, the uncoupled functional groups may further be capped using capping groups (not shown).

In order to fabricate the binary-coupled probe array 11 shown in FIG. 2, the binary-coupled probe array 12 shown in FIG. 3, or the binary-coupled probe array 14 shown in FIG. 5, some of the above-described steps may be modified. In more detail, in order to fabricate the binary-coupled probe array 11 shown in FIG. 2, the steps shown in FIGS. 6 and 7 may be skipped. In order to fabricate the binary-coupled probe array 12 shown in FIG. 3, the steps shown in FIG. 7 may be skipped. Further, in order to fabricate the binary-coupled probe array 14 shown in FIG. 5, prior to proceeding to the steps shown in FIG. 6, the first and second sub-substrates may be combined to form a combined substrate. Further details of the modified embodiments can be derived from the foregoing description.

While binary-coupled probe arrays have been described in detail through several detailed embodiments of the disclosed technology, the description is for illustrative purposes and various embodiments can be derived from the foregoing description.

According to the method of fabricating the binary-coupled probe arrays according to certain embodiments of the disclosed technology, since a plurality of probe arrays are formed on both surfaces of a substrate, highly integrated probe arrays can be fabricated, thereby further enhancing the throughput of probe arrays.

In addition, since probe arrays having the same sequences are formed on the same probe cell regions of top and bottom surfaces of the substrate, the integration level of probe cells can be enhanced. The enhanced integration level of probe cells ensures emission efficiency and fabrication of highly reliable probe arrays.

Hereinafter, a method of fabricating a biochip according to an embodiment of the disclosed technology will be described with reference to FIG. 11, which is a sectional view of intermediate structures illustrating a method of fabricating biochips according to certain embodiments of the disclosed technology.

A substrate 100 is cut along a cutting line CL to separate the substrate 100 into an upper plate 100A and a lower plate 100B. The separation of the substrate 100 is performed parallel with the top surface 101 and the bottom surface 102 of the substrate 100 based on the cutting line CL. The separation of the substrate 100 is performed by, for example, sawing. Multiple probe arrays are disposed on the separated upper plate 100A and the lower plate 100B. In such a manner, independent biochips are acquired from the upper plate 100A and the lower plate 100B, thereby doubling the yield of biochips acquired from the substrate 100, that is, further enhancing the throughput of biochips.

In the binary-coupled probe array 14 shown in FIG. 5, the combined substrate is separated into sub-substrates 210 and 220 and independent biochips are acquired, thereby further enhancing the throughput of biochips.

Furthermore, in a case where first probes 141 and second probes 142 having the same sequences are formed on the same probe cell region I of top and bottom surfaces 101 and 102 of the substrate 100, a plurality of biochips can be formed by vertically cutting the substrate 100 into predetermined units, rather than cutting the substrate 100 parallel to the top surface 101 and the bottom surface 102. Since the respective biochips have a plurality of probes 140 having the same sequences immobilized on the top surface 101 and the bottom surface 102, the integration level of biochips can be enhanced. Therefore, the emission efficiency in reacting with biological samples is enhanced, and highly reliable biochips can be attained, thereby ultimately ensuring a sufficient amount of emission even when a reduced design rule is adopted.

In binary-coupled probe arrays, biochips, and fabrication methods thereof according to certain embodiments of the disclosed technology, since the number of probe arrays formed on a substrate is doubled, the integration level and the processing efficiency can be further enhanced. Accordingly, the yield relative to the fabrication process can be further increased.

Moreover, when first and second probe arrays formed on the top and bottom surfaces of the same probe cell region are have the same sequences and are opposite to each other and face each other about the substrate, the integration level of probe arrays of the cell region can be enhanced. Accordingly, the emission efficiency of the binary-coupled probe array can be increased by the enhanced integration level, thereby increasing the reliability and ensuring sufficient emission efficiency even with a reduced design rule.

Further, in the binary-coupled probe arrays according to certain embodiments of the disclosed technology, since after forming probes on both surfaces of a substrate, the substrate is separated into an upper plate and a lower plate, unwanted formation of probes on one surface of the upper plate and the lower plate of a substrate can be prevented. Accordingly, highly reliable biochips can be fabricated.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims to indicate the scope of the invention.

What is claimed is:

1. A binary-coupled probe array comprising:
a substrate;
a plurality of first probes immobilized on a top surface of the substrate; and
a plurality of second probes immobilized on a bottom surface of the substrate.

2. The binary-coupled probe array of claim 1, wherein the substrate is a transparent substrate.

3. The binary-coupled probe array of claim 1, wherein the substrate comprises:
a plurality of probe cell regions where the plurality of first probes and the plurality of second probes are formed; and
at least one non-probe cell isolation region where the plurality of first probes and the plurality of second probes are not formed,
wherein each of the plurality of probe cell regions are isolated from one another by the at least one non-probe cell isolation region.

4. The binary-coupled probe array of claim 3, wherein the plurality of first probes immobilized on the top surface of the substrate and the plurality of second probes immobilized on the bottom surface of the substrate have the same sequences.

5. The binary-coupled probe array of claim 3, further comprising:
a first active layer formed on the top surface of the substrate overlapping with the plurality of probe cell regions, wherein the first active layer is coupled with the plurality of first probes; and
a second active layer formed on the bottom surface of the substrate overlapping with the plurality of probe cell regions, wherein the second active layer is coupled with the plurality of second probes.

6. The binary-coupled probe array of claim 3, further comprising:
first activation patterns selectively formed on the top surface of the substrate overlapping with the plurality of probe cell regions and coupled to the plurality of first probes; and
second activation patterns selectively formed on the bottom surface of the substrate overlapping with the plurality of probe cell regions and coupled to the plurality of second probes.

7. A binary-coupled probe array comprising:
a substrate having two or more sub-substrates in combination with each other;
a plurality of first probes immobilized on a top surface of the substrate; and
a plurality of second probes immobilized on a bottom surface of the substrate,
wherein each of the sub-substrates comprises:
a plurality of probe cell regions where the plurality of first probes or the plurality of second probes are formed; and
at least one non-probe cell isolation region where the plurality of first probes and the plurality of second probes are not formed,
wherein each of the plurality of probe cell regions are isolated from one another by the at least one non-probe cell isolation region.

8. The binary-coupled probe array of claim 7, wherein the substrate is a transparent substrate.

9. The binary-coupled probe array of claim 7, wherein the plurality of first probes immobilized on the top surface of the substrate and the plurality of second probes immobilized on the bottom surface of the substrate have the same sequences.

10. The binary-coupled probe array of claim 9, wherein the substrate is combined such that the probe cell regions of the respective sub-substrates are aligned with respect to each other.

11. The binary-coupled probe array of claim 9, further comprising:
a first active layer formed on the top surface of the substrate coupled with the plurality of first probes; and
a second active layer overlapping with the plurality of probe cell regions coupled with the plurality of second probes.

12. The binary-coupled probe array of claim 9, further comprising:
first activation patterns selectively formed on the top surface of the substrate overlapping with the plurality of probe cell regions and coupled to the plurality of first probes; and
second activation patterns selectively formed on the bottom surface of the substrate overlapping with the plurality of probe cell regions and coupled to the plurality of second probes.

13. A biochip comprising:
a substrate having a top surface and a bottom surface;
a first plurality of linkers formed on the top surface of the substrate;
a second plurality of linkers formed on the bottom surface of the substrate;
a plurality of first probes coupled to the first plurality of linkers; and
a plurality of second probes coupled to the second plurality of linkers.

14. The biochip of claim 13, wherein the substrate comprises:
a plurality of probe cell regions where a first plurality of probes are formed; and
a plurality of non-probe cell isolation regions where a second plurality of probes are formed,
wherein the plurality of probe cell regions are isolated from one another by the plurality of non-probe cell regions.

15. The biochip of claim 13, wherein the substrate comprises sub-substrates that are combined such that probe cell regions of respective sub-substrates are aligned with respect to each other.

16. A method of fabricating a binary-coupled probe array, comprising:
providing a substrate having a top surface and a bottom surface;
forming a plurality of first probes immobilized on the top surface of the substrate; and
forming a plurality of second probes immobilized on the bottom surface of the substrate.

17. The method of claim 16, wherein the substrate comprises a transparent substrate.

18. The method of claim 16, wherein providing the substrate comprises combining at least two sub-substrates with each other.

19. The method of claim 16, further comprising:
forming a first active layer on the top surface of the substrate before forming the plurality of first probes; and
forming a second active layer on the bottom surface of the substrate before forming the plurality of second probes.

20. The method of claim 19, further comprising:
forming a first activation pattern on the top surface of the substrate by patterning the first active layer after forming the first active layer; and
forming a second activation pattern on the bottom surface of the substrate by patterning the second active layer after forming the second active layer.

21. The method of claim 16, wherein forming the plurality of first probes and forming the plurality of second probes comprise:
selectively exposing a predetermined area of the substrate to simultaneously expose top and bottom surfaces of the predetermined area; and
simultaneously coupling the plurality of first probes to the top surface of the predetermined area and coupling the plurality of second probes to the bottom surface of the predetermined area by dipping at least the selectively exposed predetermined area of the substrate into a probe solution.

22. A method of fabricating biochips, comprising:
providing a binary-coupled probe array comprising a substrate, a plurality of first probes formed on a top surface of the substrate, and a plurality of second probes formed on a bottom surface of the substrate; and
separating the binary-coupled probe array into at least two independent biochips by cutting the binary-coupled probe array.

23. The method of claim 22, wherein the substrate comprises at least two sub-substrates combined with each other.

24. The method of claim 22, wherein separating the binary-coupled probe array into at least two independent biochips comprises separating the substrate into an upper plate and a lower plate and isolating the at least two independent biochips from respective plates.

25. The method of claim 22, wherein cutting the binary-coupled probe array comprises vertically cutting the substrate such that the plurality of first probes formed on the top surface and the plurality of second probes formed on the bottom surface are maintained.
